(19) United States
(12) Patent Application Publication
(10) Pub. No.: US 2007/0189492 A1
(43) Pub. Date: Aug. 16, 2007

(54) PEERING NETWORK FOR PARAMETER-BASED ROUTING OF SPECIAL NUMBER CALLS

(76) Inventors: George Heinrichs, Longmont, CO (US); Stephen Marc Meer, Longmont, CO (US); Michael Jay Nelson, Louisville, CO (US); Ashish Patel, Westminster, CO (US)

Correspondence Address: MICHELE ZARINELLI;c/o WEST CORPORATION, 11808 MIRACLE HILLS DRIVE, MSW11 - LEGAL, OMAHA, NE, 68154, US

(21) Appl. No.: 11/615,336

(22) Filed: Dec. 22, 2006

Related U.S. Application Data
(60) Provisional application No. 60/760,452, filed on Jan. 20, 2006.

(51) Int. Cl. H04M 7/00

(52) U.S. Cl. 379/220.01

(57) ABSTRACT

A system and method that routes special number calls from communications devices to an answering point that is selected based on a parameter. A peering network effects parameter-based routing of calls to a pre-assigned answering point, wherein the voice path and the signaling paths are set up simultaneously. A gateway in the peering network is connected to the service provider switch and receives special number calls. The gateway queries a pre-provisioned parameter server that determines call routing information for the particular communications device. The gateway then selects another gateway based on the routing information and delivers the call to the other gateway. The other gateway is connected to a router in the destination network and delivers the call and the call parameters to the router.

### CROSS-REFERENCE TO RELATED APPLICATION

This application is related to and claims the benefit of the filing date of Provisional U.S. Patent Application No. 60/760,452 entitled “Peering Network for Parameter-Based Routing of Special Number Calls” by George Heinrichs, Steven Meer, Michal Nelson and Ashish Patel, which is incorporated by reference herein in its entirety.

### BACKGROUND OF THE INVENTION

The present invention is directed to effecting routing of calls to special service numbers based on a parameter, and, more specifically, to a peering network that facilitates delivery of special number calls from a communications device to an answering point, regardless of the technological basis of the communications device and the technological basis of the answering point. In most instances, the parameter is the location of the calling communications device.

For many decades, consumer communications services were limited to a line-based telephone connected to the public switched telephone network (PSTN, also known as the “circuit switched” network). This type of telephone service is known as “plain old telephone service” or “POTS.” The POTS service provider was a local telephone company interconnected to other local telephone companies by a “long-distance” network. Most of the local telephone companies and the long-distance network were part of the Bell System. Over the decades of line-based telecommunications, consumers became accustomed to the services and operation of this telephone system.

Now, consumers not only have a choice of POTS local and long-distance service providers, consumers also have a choice of communications technologies. For example, wireless telephone service, cable television service, and high-speed Internet service are available to consumers in addition to POTS. Regardless of the technology or service provider, however, consumers still expect communications services to operate like POTS.

One of the largest problems that this consumer expectation causes is in the area of special service numbers. Such special service numbers include emergency services numbers. When a caller dials an emergency services number (such as “9-1-1” in the United States and Canada), he or she expects to be connected to an emergency services operator. Further, the caller expects that the emergency services operator is at a local public safety answering point (PSAP) that serves the emergency services zone (ESZ) where the caller is currently located. The operator can then dispatch the local police, fire, ambulance, etc. to the location of the caller. Further, it is generally expected that the operator has the calling number, the location where the call originated (i.e., the street address) and other information to aid the operator in handling an emergency.

These consumer expectations are based on the wireline implementation of emergency special number calling. The wireline network implementation, however, is based on the assumption that a wireline telephone, once installed, cannot move. If the telephone cannot move, then any information associated with the telephone number, such as the billing address (which is usually the street address where the telephone is located), will not change without the service provider knowing about it. Therefore, routines and informational databases may be safely implemented in the wireline telephone network to route emergency calls and retrieve information associated with the telephone number of the calling telephone because the telephone number is deemed to be synonymous with the telephone's location.

Thus, according to the landline paradigm, the switching system to which the telephone is attached has a standard routing routine to connect an emergency special number call to a selective router and to forward the calling telephone number. The selective router uses the calling telephone number or, in some cases, the trunk on which the call was delivered, to determine the ESZ of the caller and to connect the call to the PSAP that serves the ESZ. The selective router also forwards the calling telephone number to the PSAP. The PSAP uses the calling telephone number to query an automatic location information (ALI) database, which returns the address and other information associated with the calling telephone number. Therefore, when an operator at the local PSAP answers the call, the operator also has the calling telephone number, address of the call origination and any other information associated with the calling telephone number.

While the wireline emergency calling system is based on an association of location to telephone number, almost all other, more recent communications technologies are based on mobility. Wireless telephones are not meant to be associated with one location. Even voice over internet protocol (VoIP) telephones are not necessarily associated with one location permanently. A VoIP telephone can establish service with a data network in one location at one time and then establish service from another location and immediately make and receive calls at a different time. As such, VoIP telephone are considered to be “nomadic”.

As each new technology is introduced, consumers still expect that special service numbers will work according to the landline paradigm. In many cases, however, a call from a wireless or nomadic communications device may be routed to a generic PSAP that may be remote from the calling communications device or the call may not be routed at all. Responsive to the inevitable tragedies that occur because of the consumer expectation, there have been a series of U.S. government mandates that emergency number calls made in wireless and VoIP networks follow the same paradigm as a wireline emergency call; that is, the call is routed to a PSAP that serves the ESZ in which the calling communications device is located, regardless of the calling communications device's location relative to its billing address. Thus, each technology has had to develop methods to route calls based on a communications device's current location. Such methods are not necessarily consistent over the various technologies. In some instances, different service providers in the same technology have different methods for routing emergency calls.

The problem multiple solutions to emergency services routings is exacerbated the technology of most PSAP's. Most PSAP's were developed and installed during the dominance of circuit-switched communications technology. Therefore, most PSAP's are connected to the PSTN. The local entities that run emergency services cannot afford to support multiple technologies in all PSAP's. As a result, almost every technology must somehow route emergency calls into the PSTN at or near a selective router that can route the call to the proper PSAP and deliver location and other information.

Therefore, a problem in the art is that there is no simple, consistent system for routing a call from a communications device to a PSAP that serves the ESZ where the communications device is currently located regardless of the technology of the communications device and the PSAP.

### SUMMARY OF THE INVENTION

This problem is solved and a technical advance is achieved in the art by a system and method that routes special number calls from communications devices to an answering point based on one or more parameters, such as location of the communications device. In accordance with this invention, a peering network effects routing of special number calls to one of a plurality of answering points selected by a parameter and wherein the voice path and the signaling paths are set up simultaneously.

A first gateway in the peering network is connected to a router in the service provider network. When the router in the service provider network receives a special number call, it delivers the call to the first gateway along with any information the router has. The first gateway queries a parameter server that determines call routing information for the particular parameter. The first gateway then selects a second gateway from a plurality of second gateways based on the routing information and delivers the call to the selected second gateway. The second gateway is connected to a router in the destination network and delivers the call and the call parameters to the router. For purposes of describing this invention, a “router” may be a circuit switch, a data network router, a soft switch, a mobile switching center or the like. The network may be circuit switched, data, Internet protocol, wireless or any combination thereof.

Importantly, this invention provides location-based routing of special number calls regardless of the communications technology of the calling communications device and the technology of the answering point. Thus, this invention provides location-based routing of special number calls from a communications device on any service provider network to any answering point on any communications network, including, but not limited to, the public switched telephone network.

Further advantageously, the location of the calling communications device is the parameter that is used to determine the emergency services zone and the public safety answering point that serves that emergency services zone. Thus, this invention enables service providers to provide special number calling for all of their respective customers, regardless of where the communications device is currently located and regardless of whether the service provider also provides the answering point.

### BRIEF DESCRIPTION OF THE DRAWINGS

A more complete understanding of this invention may be obtained from a consideration of this specification taken in conjunction with the drawings, in which:

FIG. 1 illustrates an overview block diagram of a communications network in accordance with an exemplary embodiment of the present invention;

FIG. 2 is a block diagram of the emergency services peering network of FIG. 1 in accordance with an aspect of this invention;

FIG. 3 illustrates a block diagram of a communications network in accordance with another aspect of the present invention;

FIG. 4 is a call flow diagram of a special number call from a communications device to its assigned answering point in the context of FIG. 3;

FIG. 5 illustrates a block diagram of a communications network in accordance with a further aspect of this invention;

FIG. 6 is a call flow diagram of a special number call from a communications device to its assigned answering point in the context of FIG. 5;

FIG. 7 illustrates a block diagram of a communications network in accordance with yet another aspect of this invention; and

FIG. 8 is a call flow diagram of a special number call from a communications device to its assigned answering point in the context of FIG. 7.

### DETAILED DESCRIPTION

The present invention relates to routing of a special number call to an answering point based on a parameter and regardless of whether the call crosses network boundaries. For purposes of this specification, “network boundaries” means the interface between two service provider networks (e.g., AT&T and Verizon) and the interface between networks of diverse technologies (e.g., VoIP and circuit switched networks). The various embodiments of this invention are described in terms of the special number call being an emergency services call, also referred to herein as a “9-1-1 call.” However, one skilled in the art will realize how to use the principals of this invention for other special number calls (e.g., 3-1-1, 800 numbers, 900 numbers, international calls, etc.) or for general call processing after studying this specification. While this specification is described in terms of call processing within or across technologies, one skilled in the art will appreciate how to adapt this invention to expedite connections between other types of communications devices after studying this specification.

As described above, a 9-1-1 call is routed to a public safety answering point (PSAP) that service the emergency services zone (ESZ) where the calling communications device is located. Not all networks, however, can obtain location information in the same manner, which means that each time a new communications technology is introduced, the problem of determining the location of a calling communications device when it makes an emergency services call must be addressed all over again. Further, the problem of how to deliver location information for routing and other purposes must also be addressed.

These problems are addressed by an emergency services peering network in accordance with this invention. In the emergency services peering network, both the signaling path and the voice path of the emergency services call are handed off to the emergency services peering network as soon as is practical, given the network of origin. All information that the service provider network has is advantageously delivered simultaneously. The emergency services peering network then uses whatever information it has or can obtain, determines a route through the emergency services peering network to the PSAP that serves the ESZ wherein the calling communications device is located and transports the call to that PSAP or to an emergency services network that is associated with the PSAP.

As will be described further, below, in connection with the various embodiments, the voice path and the call set-up signaling path move through the emergency service peering network approximately simultaneously. Thus, there is no time lag between signaling set up and actual call set up. It is known in the art that a caller who dials 9-1-1 is apt to hang up and try again if the call is not answered within seconds. This invention expedites call set up for emergency calling, which expedites aid and prevents repeated 9-1-1 calls, which saves network resources.

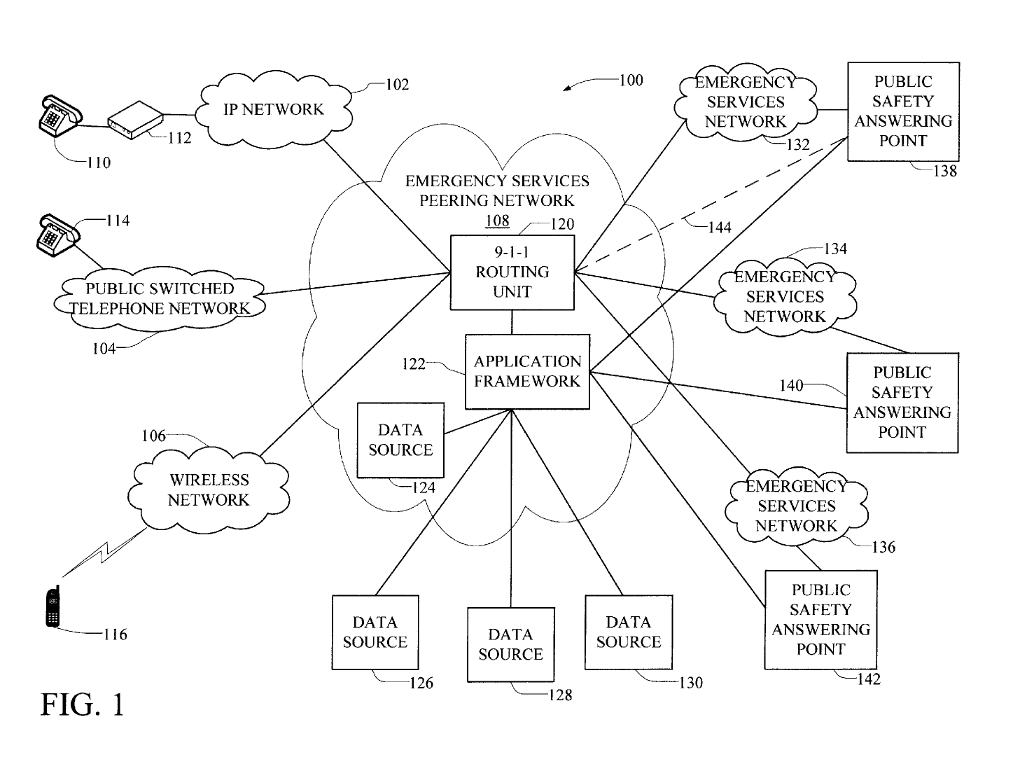

FIG. 1 illustrates a overview of a communication network 100 in which an exemplary embodiment of this invention operates. This exemplary embodiment of this invention is described herein in the context of a telephone making a special services call (a “9-1-1 call”) to an emergency services number answering point, or PSAP. Because routing a call to a local PSAP is generally based upon location-based parameters, this embodiment is described in the context of routing a call based on the location of the calling communication device. One skilled in the art will appreciate how to modify this invention to effect voice or data routing for predetermined destinations based on one or more parameters after studying this specification.

The exemplary communications network 100 of FIG. 1 comprises an IP network 102, a public switched telephone network 104, a wireless network 106 and an emergency services peering network 108 in accordance with this invention. IP network 102 provides voice over internet protocol (VOIP) between and among VoIP-enabled telephones connected to IP network 102. Such VoIP-enabled telephones are represented by telephone 110, which is connected to IP network 102 via a modem 112. Modem 112 is not absolutely required and/or may be part of VoIP telephone 110, as is known in the art. IP network 102, VoIP telephone 110 and modem 112 are well known in the art, are not part of this invention and are therefore not described further.

Communications network 100 also comprises a public switched telephone network (PSTN) 104, which comprises one or more service provider circuit switched networks. PSTN 104 provides voice circuit connections between and among line-based telephones, represented by telephone 114. PSTN 104 and telephone 114 are well known in the art, are not part of this invention and are therefore not described further.

Communications network 100 further comprises a wireless network 106. Wireless network 106 provides wireless voice and data telephony between and among wireless communications devices, represented by wireless telephone 116. Wireless network 106 and wireless telephone 116 are well known in the art, are not part of this invention and are therefore not described further.

IP network 102, PSTN 104 and wireless network 106 are all interconnected, so that a call that originates on one of the communications networks can be delivered in any of the networks. This interconnection is not shown for clarity. Communications network 100 may include other IP, wireless or public switched telephone networks, whether they are interconnected to other networks or are private networks. IP network 102, PSTN 104 and wireless network 106 are for illustration only and not for limitation. One skilled in the art will appreciate that any network supported by any technology will work with the current invention after studying this specification.

Communications network 100 also includes emergency services peering network 108, in accordance with this invention. In this overview FIG. 1, emergency services peering network 108 comprises 9-1-1 routing unit 120 interconnected to an application framework 122. Application framework 122 generally provides data management and retrieval and is connected to a plurality of data sources internal to emergency services peering network 108, represented by data source 124. Application framework 122 is also connected to a plurality of data sources outside of emergency services peering network 108, represented by data source 126, data source 128 and data source 130. Data sources 124, 126, 128 and 130 may comprise any form of data source including, but not limited to, VoIP position centers, mobile position centers, ALI databases, etc. Data sources 126, 128 and 130 may be stand-alone data sources, may be interconnected or may be part of IP network 102, PSTN 104 or wireless network 106.

Both 9-1-1 routing unit 120 and application framework 122 are connected to a plurality of emergency services networks represented by emergency services network 130, emergency services network 132 and emergency services network 134. Each emergency services network 132, 134 and 136 routes emergency calls to a plurality of PSAP's, represented by PSAP 138, PSAP 140 and PSAP 142. Each PSAP 138, 140 and 142 is connected by data channels to application framework 122 either directly or via one or more data networks (not shown but well known in the art).

Emergency services networks 132, 134 and 136 generally comprise one or more selective routers as is known in the art. The selective routes may be part of PSTN 104 (as is currently practiced in the art) or may be, for example, part of an IP network. Further, PSAP's 138, 140 and 142 are connected to their respective emergency services network via trunks (as is currently practiced in the art) or may be end points in an IP network. Additionally, a PSAP, such as PSAP 138, may be a VoIP-based PSAP, and as such may be connected directly to 9-1-1 routing unit 120 via an IP link 144 (shown in phantom). One of the major advantages of this invention is that an emergency services peering network in accordance with this invention effects connection of 9-1-1 calls between and among communications networks of any technology.

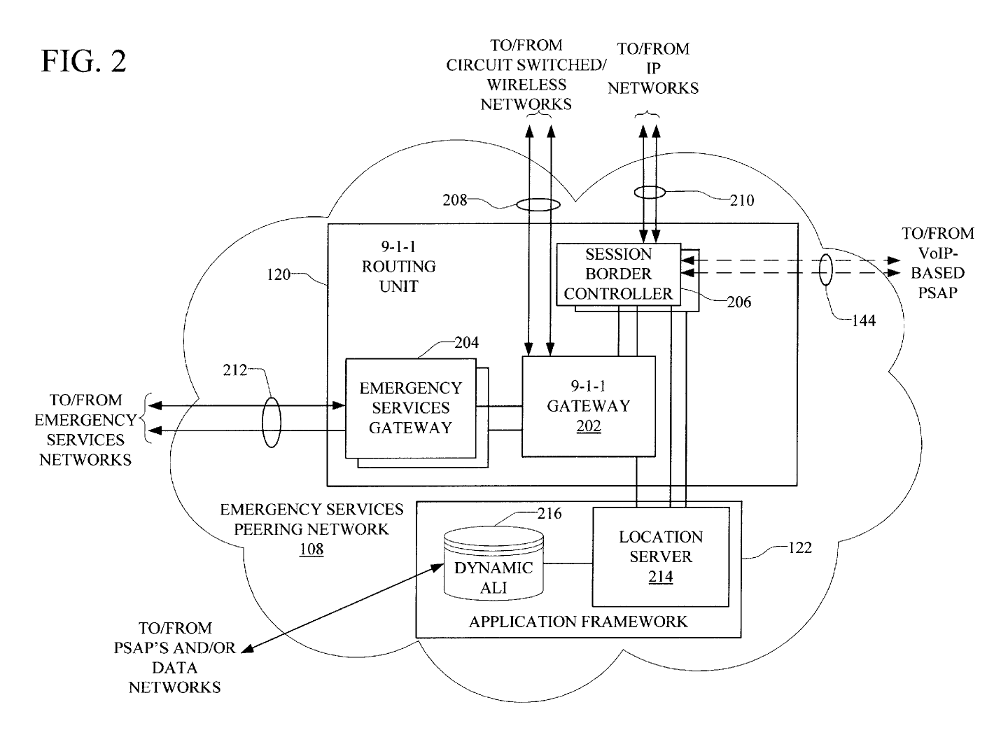

FIG. 2 is a block diagram of the major components of an emergency services peering network 108 in accordance with this invention. As stated above, emergency services peering network 108 generally comprises a 9-1-1 routing unit 120 and an application framework 122. 9-1-1 routing unit 120 comprises a 9-1-1 gateway 202, one or more emergency services gateways 204 and one or more session border controllers 206.

9-1-1 gateway 202 receives incoming 9-1-1 calls either via trunks 208 from circuit-switched networks (e.g., PSTN 104, wireless network 106, etc.) or via a data connection 210 through session border controller 206 from IP or other data networks (e.g., IP network 102). 9-1-1 gateway 202 performs terminations as appropriate for trunks 208, according to this exemplary embodiment. Session border controller 206 terminates IP connections 210 and forwards the data to 9-1-1 gateway 202. Alternatively, session border controller 206 may act as a forwarding point and deliver the call to an IP-based PSAP via IP links 144.

9-1-1 gateway 202 cooperates with application framework 122 to determine routing for the call and selects an emergency services gateway 204 accordingly. 9-1-1 gateway 202 forwards the call to the selected emergency services gateway 204 and passes any information it has regarding the call, either received directly on trunks 208, via session border controller 206 or from application framework 122. Emergency services gateway 204 forwards the call to the emergency services network closest to the origin of the call via 212. Elements 212 may be circuit switched trunks if the emergency services network is in the PSTN or may be IP data lines or networks if the emergency services network comprises a data network.

Communications paths through 9-1-1 routing unit 120 comprise, in this exemplary embodiment, IP links using VoIP protocol. One skilled in the art will be able to connect the various communications elements of 9-1-1 routing unit 120 using other types of communications connections such as, but not limited to, circuit switching, after studying this specification. Further, this exemplary embodiment is described in terms of three separate units performing three separate functions. One skilled in the art will understand that the various elements within 9-1-1 routing unit 120 may comprise only one unit or may be several units on distributed platforms after studying this specification. This exemplary embodiment of this invention is also intending to have redundant elements to enhance reliability. Such redundant elements are not shown in order that the drawings may be more readily understandable, but one skilled in the art will be able to implement N-way or N+1 redundancy after studying this specification.

Application framework 122 is illustrated in FIG. 2 as comprising a location server 214 and dynamic ALI 216. Location server 214 and dynamic ALI 216 cooperate to provide the location parameter to 9-1-1 gateway 202 for routing determinations and to provide location information to location ALI units (not shown but well known in the art). Application framework is more fully described in the following U.S. patent applications: Ser. No. 10/817,738 by Mike Nelson, Greg Bruening, Ed Kizhner, Stephen Bulick, Dennis Neumayer, Robert Sherry and Stephen Meer, which was filed Apr. 2, 2004 and is entitled “Dynamically Establishing Media Channel Between Resources of an Emergency Services Network and Conforming Emergency Systems-Next Gen;” Ser. No. 10/816,613 by Stephen Meer, Greg Bruening, Larry Ciesla , Mike DeWeese, Mike Nelson, Pete Schmidt, Bob Sherry and John Snapp, which was filed Apr. 2, 2004 and is entitled “Communication Network for Providing Emergency Services;” Ser. No. 10/816,634 by Mike Nelson, Greg Bruening, Ed Kizhner, Stephen Bulick, Dennis Neumayer, Robert Sherry and Stephen Meer, which was filed Apr. 2, 2004 and is entitled “Rotating Media Channels Between Resources of an Emergency Services Network and Conforming Emergency System;” Ser. No. 10/816,735 by Mike Nelson, Greg Bruening, Pete Schmidt, Bob Sherry and Stephen Meer, which was filed Apr. 2, 2004 and is entitled “Method and Apparatus for Increasing the Reliability of an Emergency Call Communication Network-Next Gen” which is now U.S. Pat. No. 7,123,693; and Ser. No. 10/816,633 by Stephen Meer, Greg Bruening, Larry Ciesla, Mike Nelson and Pete Schmidt, which was filed Apr. 2, 2004 and is entitled “Bi-directional Messaging for an Emergency Services Network- Next Gen;” all of which are assigned to the same assignee of this patent application and all of which are incorporated herein by reference in their entirety.

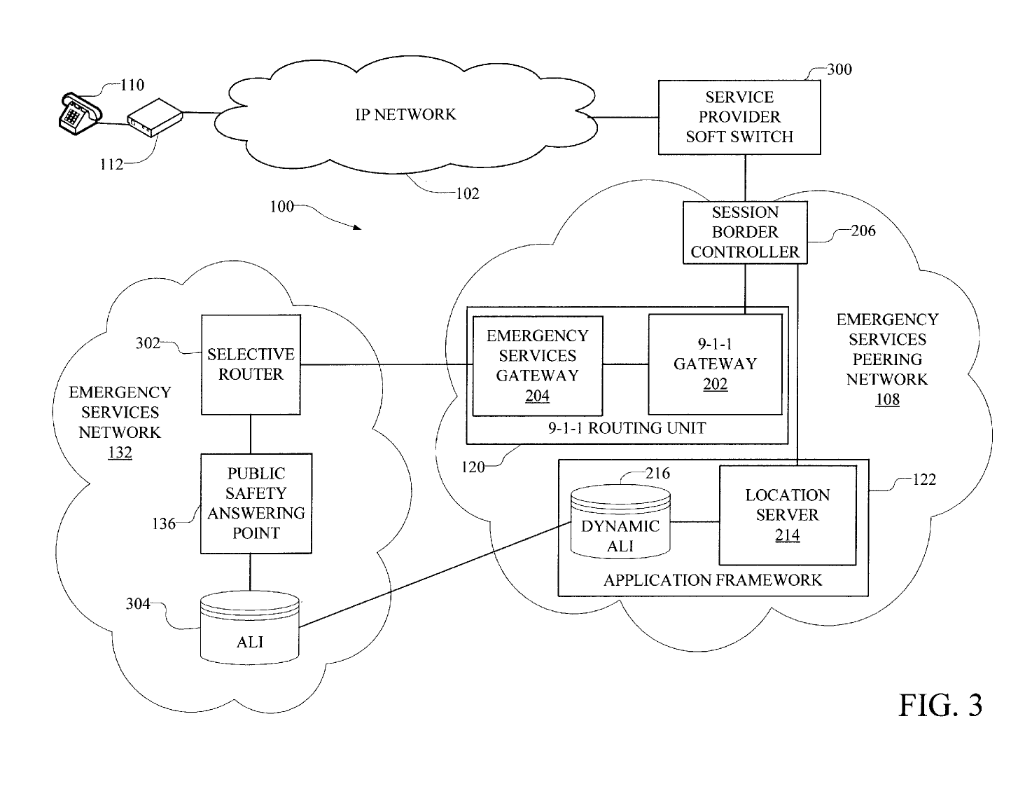

FIGS. 3-8 describe call flows from networks based on diverse technologies, through emergency service peering network 108 and to a PSAP proximal to the location of the calling device, in accordance with various aspects of this invention. In order to keep this application to a reasonable length, only one of several possible scenarios is presented to illustrate the principals of this invention. One skilled in the art will be able to vary the details of connections and protocols of the scenarios to adapt this invention to specific applications after reading this specification.

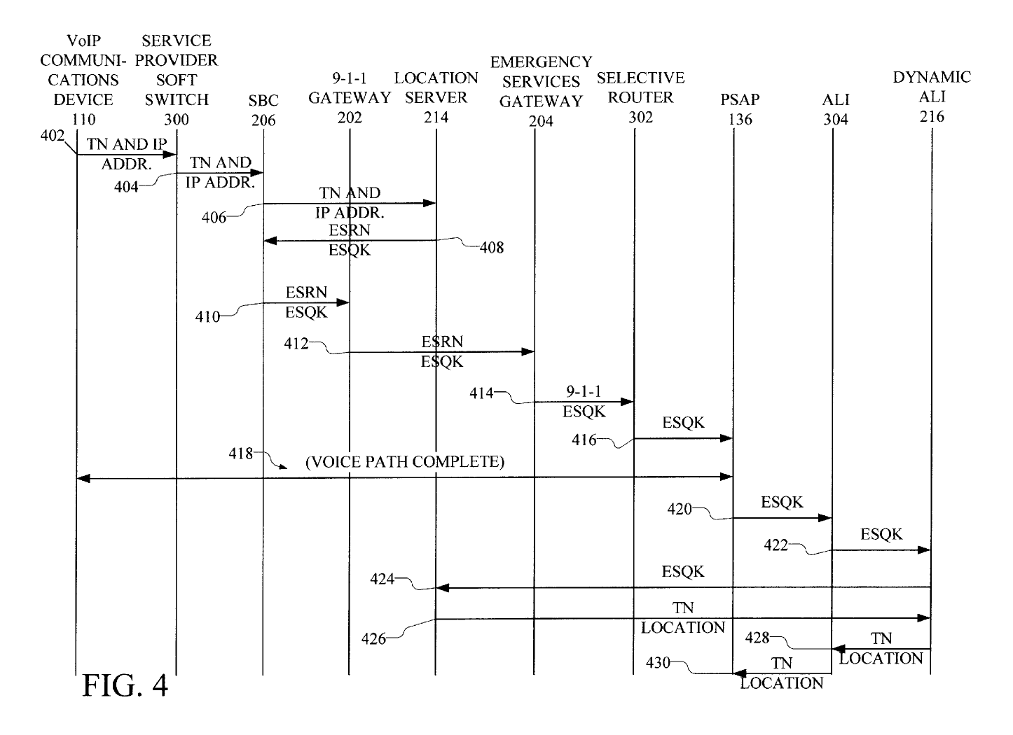

Turning now to FIGS. 3 and 4, an emergency services call between VoIP telephone 110 and its local serving PSAP 136 is now described in the context of the call flow of FIG. 4 taken in conjunction with the communications network 100 of FIG. 3. For purposes of describing this aspect of this invention, PSTN 104 and wireless network 106 are not shown for clarity. The steps of FIG. 4 are in parentheses after the step's description in the context of FIG. 3.

The call flow of FIG. 4 begins when the user of VolP communications device 110 dials 9-1-1 and the call is sent into IP network 102. The initial message includes at least the telephone number (herein “TN,” but also known in the art as directory number “DN”) of the VoIP communications device 110 and may also include its IP address. (402) The call is received at the service provider soft switch 300 wherein digit analysis is performed. One skilled in the art understands that service provider soft switch 300 is part of IP network 102 and may be in any location in relation to VoIP communications device 110.

In this exemplary embodiment, service provider soft switch 300 recognizes the special number digits, sets up and delivers the call via an IP channel to session border controller 206. (404) Session border controller (SBC) 206 determines how to route the call by querying location server 214 in application framework 122 with the TN and optionally the IP address of VolP communications device 102. (406) location server 214 responds with an emergency services routing number (ESRN) and an emergency services query key (ESOK). (408) ESRN comprises a unique number that identifies the selective router that supports call to the appropriate PSAP (in this example, the selective router is 302 and the PSAP is 136). ESQK comprises a number that indicates to the selective router which PSAP to deliver the call to and to indicate that there is additional information. Location server 214 may query other data sources internal and external to application framework 122, as appropriate, determine the location of the caller.

Session border controller 206 sets up and delivers the call to 9-1-1 gateway 202 in 9-1-1 routing unit 120 and forwards the ESRN and ESQK. (410) Alternatively, session border controller 206 may forward the call immediately upon receipt from service provider soft switch 300 and 9-1-1 gateway 202 queries location server 214. In either alternative, gateway 124 selects an emergency service gateway 126 based on the ESRN and forwards the call, including the ESRN and ESQK, thereto. (412)

Emergency services gateway 204 routes the call to a selective router 302 in emergency services network 132 based on the ESRN, and delivers “9-1-1” as the called number and ESQK as the called number. (414) Selective router 302 selects one of the PSAP's to which it is connected based on the ESQK and routes the call to PSAP 136 and delivers the ESQK. (416) The voice path between VoIP communications device 110 and PSAP 136 is complete at this point. (418)

PSAP 132 obtains the calling number and location information by querying its ALI database 304 with the ESQK. (420) ALI database 304 recognizes the ESQK as requiring special handling and queries dynamic ALI 216 with the ESQK (422), which then queries location server 214 with the ESQK. (424) Location server 214 delivers the TN of VoIP communications device 110 and its location back to dynamic ALI 216. (426) Dynamic ALI 216 delivers the TN and location of VoIP communications device 110 back to ALI 304 (428) and ALI 304 delivers the TN and location of VoIP communications device 110 to PSAP 136. (430)

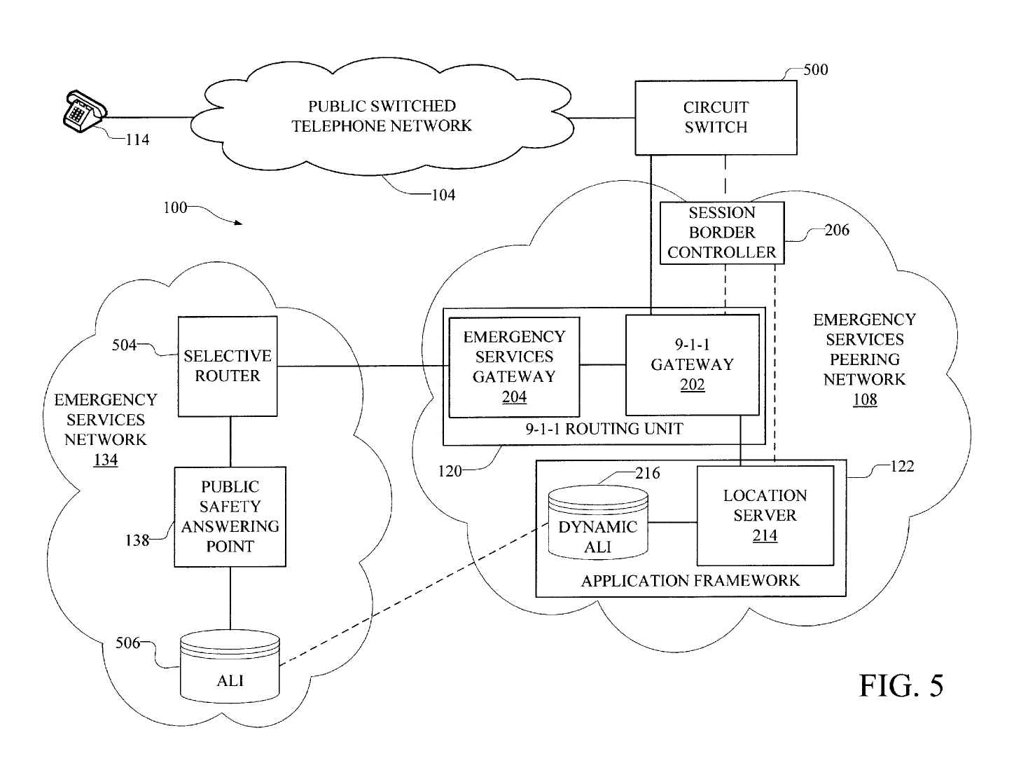

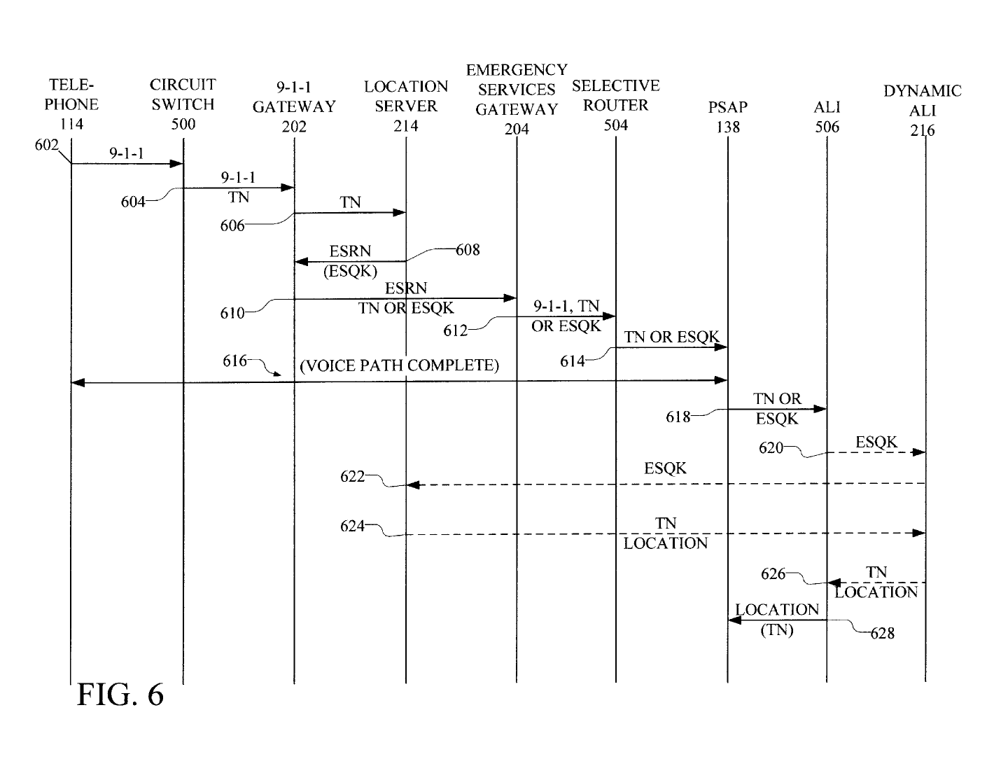

Turning now to FIG. 5, a further embodiment of this invention is shown in the context of communications network 100. This further exemplary embodiment describes the operation of emergency services peering network 108 for a call from a POTS telephone 114 from PSTN 104. The steps of FIG. 6 are in parentheses after the step's description in the context of FIG. 5.

The user of POTS telephone 114 initiates an emergency services call by dialing 9-1-1. The call is routed to circuit switch 500. (602) There may be one or more intermediate switches in PSTN 104, as is known in the art. Circuit switch 500 recognizes the called number (9-1-1) as requiring special routing and forwards the call into emergency services peering network 108 at 9-1-1 gateway 202. Circuit switch 500 forwards the called number (9-1-1) and the calling number, which is the TN of telephone 114 to 9-1-1 gateway. (604) The connection between circuit switch 500 and 9-1-1 gateway 202, in this exemplary embodiment, comprises a circuit switched line, a trunk, a PRI, etc. Alternatively, if the connection between circuit switch 500 and emergency services peering network 108 is via IP, then circuit switch 500 is connected via data lines (shown in phantom) to session border controller 206. In this scenario, call processing form this point forward proceeds generally in the same manner as in FIG. 4.

Continuing with FIG.'s 5 and 6, 9-1-1 gateway 124 passes the TN of the calling telephone to location server 214 in order to determine routing information. (606) Location server 214 queries one or more of the plurality of data sources 124, 126, 128 and 130 (FIG. 1) with the TN to determine the location of telephone 114 for routing and reporting purposes. In fact, location server 214 may query any ALI database that might have location information associated with the TN. Thus, application framework 122 may query a regional ALI or may query an ALI in one or more of the emergency services networks. One skilled in the art will appreciate the versatility of application framework 122 in determining the location of a calling communication unit, whether stationary, nomadic or mobile, after studying this specification and the above-included references.

Location server 214 returns an ESRN and, optionally, an ESQK to 9-1-1 gateway 124. (608) The ESQK may be necessary in cases where the location of telephone 114 is determined in a dynamic manner and may not match the location or TN as stored in a local ALI (e.g., when the billing location and the actual location are not the same).

9-1-1 gateway 124 selects an emergency services gateway 204 based on the ESRN, delivers the call to the selected emergency services gateway 204 and forwards the ESRN and the TN or ESQK (or both, depending upon the application). (610) Emergency services gateway 204 delivers the call to selective router 504 in emergency services network 134, forwarding 9-1-1 as the called number and the actual TN or the ESQK as the calling number. (612) Selective router uses the TN or ESQK to select a PSAP and then routes the call to the selected PSAP, which is PSAP 138 in this exemplary embodiment, and forwards the TN or ESQK. (614) A voice path is now established from telephone 114, through emergency services peering network 108 to PSAP 138. (616)

PSAP 138 queries ALI 506 with the TN or ESQK. (618) If an ESQK was received, then ALI 506 queries dynamic ALI 216 with the ESQK. (620) Dynamic ALI 216 queries location server 214 with the ESQK. (622) Location server 214 responds with the TN and location of telephone 114 (624), which is forwarded to ALI 506. (626) If local ALI 506 is queries with a TN, then steps 620 through 626 are not performed. ALI 506 returns location information and, optionally, the TN, to PSAP 138. (628)

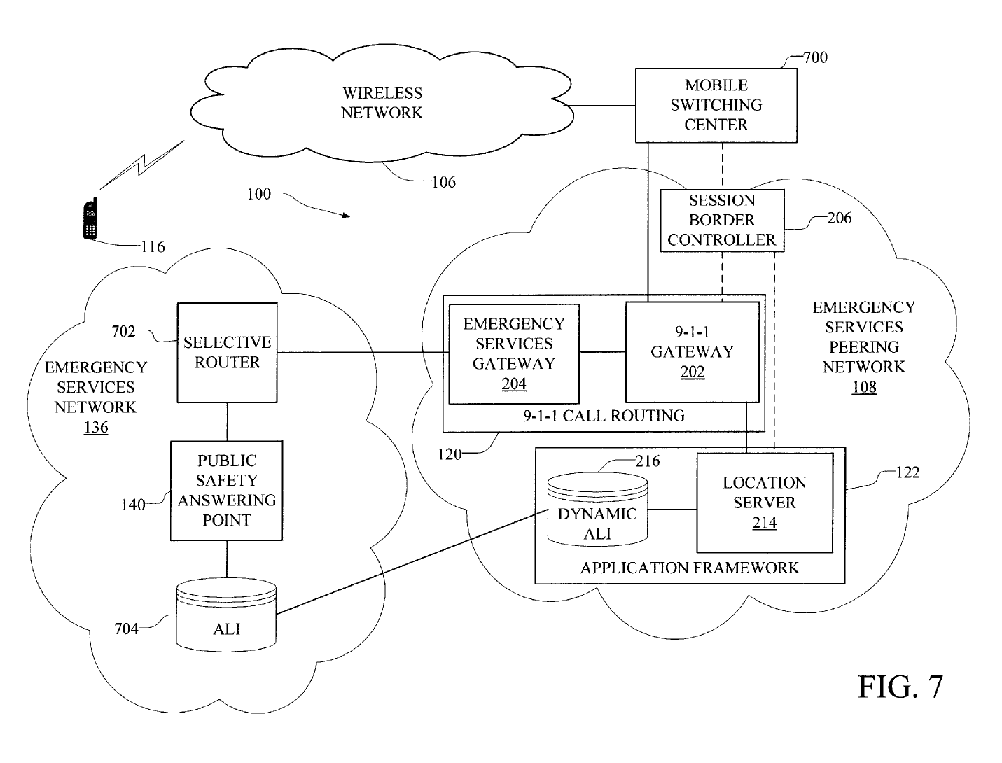

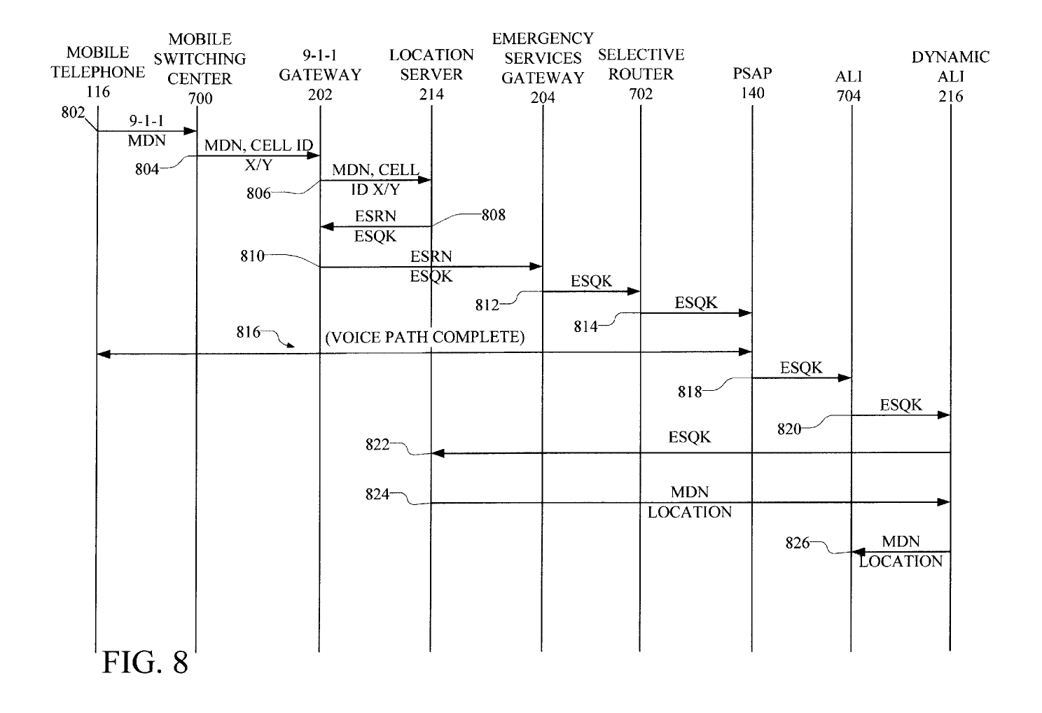

Turning now to FIG. 7, a further embodiment of this invention is shown in the context of communications network 100. This further exemplary embodiment describes the operation of emergency services peering network 108 for a call from a wireless telephone 116 from wireless network 106. The steps of FIG. 8 are in parentheses after the step's description in the context of FIG. 7.

The user of wireless telephone 116 initiates an emergency services call by entering 9-1-1 and sending the call into wireless network 106, wherein the call is routed to mobile switching center 700. (802) Mobile switching center 700 receives the called number (9-1-1) and the calling mobile directory number (MDN), as is known in the art. Mobile switching center 700 recognizes the called number, 9-1-1, as requiring special handling. Mobile switching center 700 obtains cell ID and an estimate of X/Y, as is known in the art.

Mobile switching center then forwards the call into emergency services peering network 108 to 9-1-1 gateway 202, passing at least the MDN and cell ID and X/Y, if available. (804) As is known in the art, mobile switching center sends this information in a subscriber location request (SLR) message to a location center. The same message may be sent to 9-1-1 gateway along with the voice path in this exemplary embodiment.

The connection between mobile switching center 700 and 9-1-1 gateway 202, in accordance with this exemplary embodiment, may be via a circuit switched line, trunks, PRI, etc. Alternatively, if the connection between mobile switching center 700 and emergency services peering network 108 is via IP, then mobile switching center 700 is connected via data lines (shown in phantom) to session border controller 206. In this scenario, call processing from this point on proceeds generally in the same manner as in FIG. 4.

Continuing with FIGS. 7 and 8, 9-1-1 gateway 124 passes whatever information regarding the call (at least the MDN) to location server 214 in order to determine routing information. (806) Location server 214 queries one or more of the plurality of data sources 124, 126, 128 and 130 (FIG. 1) with the received information to determine the location of mobile telephone 116 for routing and reporting purposes.

Location server 214 returns an ESRN and an ESQK to 9-1-1 gateway 124. (808) 9-1-1 gateway 124 selects an emergency services gateway 204 based on the ESRN, delivers the call to the selected emergency services gateway 204 and forwards the ESRN and the ESQK. (810) Again, location server 214 may use any resource internal or external to application framework 122 to determine location.

Emergency services gateway 204 delivers the call to selective router 702 in emergency services network 136, forwarding 9-1-1 as the called number and the ESQK. (812) Selective router uses the ESQK to select a PSAP and then routes the call to the selected PSAP, which is PSAP 140 in this exemplary embodiment, and forwards the ESQK. (814) A voice path is now established from telephone 114, through emergency services peering network 108 to PSAP 138. (816)

PSAP 138 queries its local ALI 704 with the ESQK. (818) ALI 704 queries dynamic ALI 216 with the ESQK. (820) Dynamic ALI 216 queries location server 214 with the ESQK. (822) Location server 214 responds with the MDN and location of mobile telephone 116 (824), which are forwarded to ALI 704. (826)

It is to be understood that the above-described embodiment is merely illustrative of the principles of the present invention and that many variations of the above-described embodiments can be devised by one skilled in the art without departing from the scope of the invention. It is therefore intended that such variations be included within the scope of the following claims and their equivalents.

1. A peering network for parameter-based routing of special number calls comprising:
a parameter server configured to determine a path through said peering network based on a parameter;
a first gateway configured to receive a special number call from a communications device connected to a service provider network responsive to said parameter server;
a call transport network connected to said first gateway and configured to transport said call through said peering network responsive to said parameter server; and
a second gateway connected to said call transport network and a special number answering point and configured to receive said call from said call transport network and deliver said call to said special number answering point responsive to said parameter server.

2. A peering network in accordance with claim 1 wherein said parameter comprises a location of said communications device.

3. A peering network in accordance with claim 1 wherein said parameter server determines said parameter from information provided by said service provider network.

4. A peering network in accordance with claim 1 further including:
an application server connected to said parameter server and configured to determine said parameter based on information regarding communication device.

5. A peering network in accordance with claim 4 wherein said parameter comprises a location of said communication device.

6. A peering network in accordance with claim 1 wherein said communications device comprises a POTS telephone and said communications network comprises a circuit-switched network.

7. A peering network in accordance with claim 1 wherein said communications device comprises a wireless communications device and said communications network comprises a wireless network.

8. A peering network in accordance with claim 1 wherein said communications device comprises a VoIP communications device and said communications network comprises a VoIP network.

9. A peering network in accordance with claim 1 wherein said call transport network comprises an Internet protocol network.

10. A peering network in accordance with claim 1 wherein said special number answering point comprises a special number services network comprising a plurality of special number answering points.

11. A peering network in accordance with claim 1 wherein said special number comprises an emergency services number.

12. A peering network in accordance with claim 1 wherein said special number comprises 9-1-1.

13. A method for delivering a special number call comprising:
receiving a special number call from a service provider network at a peering network;
routing said special number call through said peering network based on a parameter associated with said call; and
delivering said special number call to a special number answering point.

14. A method in accordance with claim 13 further comprising:
deriving said parameter from information delivered with said call.

15. A method in accordance with claim 14 wherein said peering network includes an application framework and wherein deriving said parameter comprises said application framework deriving said parameter from parameter sources within said peering network based on said information delivered with said call.

16. A method in accordance with claim 14 wherein said peering network includes an application framework and wherein deriving said parameter comprises said application framework deriving said parameter from parameter sources outside of said peering network based on said information delivered with said call.

17. A method in accordance with claim 14 wherein said peering network includes an application framework and wherein deriving said parameter comprises said application framework deriving said parameter from parameter sources within said service provider network based on said information delivered with said call.

18. A method in accordance with claim 13 wherein delivering said call to a special number answering point comprises handing off said call to a special number services network and delivering information regarding the call to route the call through the special number services network to a special number answering point.

19. A method in accordance with claim 13 wherein delivering said call to a special number answering point comprises delivering said call and information regarding said call directly to said special number answering point.

20. A method in accordance with claim 13 wherein said peering network comprises a plurality of gateways and wherein routing said call through said peering network comprises routing said call from a first gateway to at least one other of said plurality of gateways.
